(19) United States
(12) Patent Application Publication
(10) Pub. No.: US 2017/0098045 A1
(43) Pub. Date: Apr. 6, 2017

(54) LOCATION-BASED AUTOMATED STAFF-TO-PATIENT ASSIGNMENT SYSTEM AND METHOD

(71) Applicant: Hill-Rom Services, Inc., Batesville, IN (US)

(72) Inventors: Bradley T. Smith, Raleigh, NC (US); Joshua P. Lingenfelser, Fuquay Varina, NC (US); Matthew D. Morgan, Cary, NC (US); Andrew S. Robinson, Durham, NC (US); David M. Girardeau, Pittsboro, NC (US)

(21) Appl. No.: 15/267,197

(22) Filed: Sep. 16, 2016

Related U.S. Application Data
(60) Provisional application No. 62/237,208, filed on Oct. 5, 2015.

(51) Int. Cl. G06F 19/00

(52) U.S. Cl. CPC G06F 19/327

(57) ABSTRACT

Technologies for location-based automated assignment of staff members of a healthcare facility include a plurality of proximity sensing devices communicatively coupled to a computer. The proximity sensing devices are each configured to detect a portable transceiver device carried by and associated with a particular staff member of the healthcare facility, as well as transmit location information to the computer. The computer is configured to receive the location information and determine whether to assign the staff member to a location of the staff member (i.e., the location of the proximity sensing device that detected the portable transceiver device). The computer is further configured to assign the staff member to the location of the staff member, as identified in the location information, based on a determination that the amount of time the staff member is detected in the location exceeds the duration threshold. Other embodiments are described herein.

The present application claims the benefit, under 35 U.S.C. §119(e), of U.S. Provisional Application No. 62/237,208, filed Oct. 5, 2015, and which is hereby incorporated by reference herein in its entirety.

### BACKGROUND

The present disclosure relates generally to systems and methods for assigning staff, such as caregivers, to patients in a healthcare facility.

Nurse call systems are typically used in healthcare facilities to track patient and caregiver data, such as room assignments, medical device component assignments, health-related data, etc. In particular, nurse call systems can be used to assign a particular staff member (e.g., a caregiver) of the healthcare facility to a patient. Typically, such assignment is performed manually by an administrator (e.g., a caregiver or head nurse tasked with managing scheduling) responsible for assigning caregivers to one or more patients at a particular workstation. Such manual assignment can result in wasted “man-hours,” financial capacity, and/or other resources. In some healthcare facilities, staff members may wear or otherwise carry identifying technologies, such as a radio-frequency identification (RFID) smartcard, tag, or badge that interfaces with the various sensors such that data of the identifying technology (e.g., an identifier of the tag associated with a caregiver) can be attributed to a particular member of the staff. As a result, the whereabouts of each staff member can be tracked throughout the healthcare facility. The terms “tags” and “badges” are used interchangeably herein.

### SUMMARY

The present application discloses one or more of the features recited in the appended claims and/or the following features which, alone or in any combination, may comprise patentable subject matter.

According to a first aspect of the present disclosure, a method for location-based automated assignment may include receiving, by a computer, location information from a proximity sensing device communicatively coupled to the computer. The proximity sensing device is located in a nursing unit of a healthcare facility. The location information includes an identifier of a staff member of the healthcare facility associated with a portable transceiver device detected by the proximity sensing device and a location of the proximity sensing device in the healthcare facility that detected the portable transceiver device. The method may further include determining, by the computer, whether to assign the staff member to the location of the staff member based on whether an amount of time the staff member is detected in the location exceeds a duration threshold. The method may further include assigning, by the computer, the staff member to the location of the staff member based on a determination that the amount of time the staff member is detected in the location exceeds the duration threshold.

In some embodiments assigning the staff member to the location comprises assigning the staff member to a patient assigned to the location. In some embodiments the location of the staff member comprises a room of a patient of the healthcare facility. Alternatively or additionally, the location of the staff member comprises a nursing unit of the healthcare facility.

In some embodiments the method further comprises determining, by the computer, an assigned area of the staff member, comparing, by the computer, the location of the staff member and the assigned area of the staff member to determine whether to assign the staff member to the location. The method may further include determining, by the computer, the amount of time the staff member is detected in the location. Further, the method may also include assigning the staff member to the location comprises assigning the staff member to a patient assigned to the location based on the location of the staff member and a determination that the amount of time the staff member is detected in the location exceeds the duration threshold.

In some embodiments determining the amount of time the staff member is at the location comprises determining an amount of time the portable transceiver device has been detected at the location.

In some embodiments the method may further include receiving, by the computer and subsequent to assigning the staff member to the location of the staff member, additional location information for the staff member from another proximity sensing device located at another location different than the location. The method may also include determining, by the computer, the amount of time the staff member is detected in the other location. Further, the method may include cancelling, by the computer, the assignment of the staff member to the location of the staff member to which the staff member was previously assigned. Further still, the method may include assigning, by the computer, the staff member to the other location in response to a determination that the amount of time the staff member is detected in the other location exceeds the duration threshold.

In some embodiments, assigning the staff member to the other location comprises assigning the staff member to a patient assigned to the other location.

According to yet another aspect of the present disclosure, a system may include a plurality of proximity sensing devices located in different locations in a nursing unit of a healthcare facility, wherein each of the proximity sensing devices may detect a portable transceiver device associated with a staff member. The system may include a computer communicatively coupled to the proximity sensing devices, wherein the computer may receive location information from each of the proximity sensing devices, wherein the location information includes an identifier of the staff member of the healthcare facility associated with a portable transceiver device detected by the proximity sensing device and a location of the proximity sensing device in the healthcare facility that detected the portable transceiver device. The computer may be further determine whether to assign the staff member to the location of the staff member based on whether an amount of time the staff member is detected in the location exceeds a duration threshold. Further, the computer may also assign the staff member to the location of the staff member based on a determination that the amount of time the staff member is detected in the location exceeds the duration threshold.

In some embodiments, to assign the staff member to the location comprises to assign the staff member to a patient assigned to the location. In some embodiments, the location of the staff member comprises a room of a patient of the healthcare facility. Additionally or alternatively, in some embodiments, the location of the staff member comprises a nursing unit of the healthcare facility.

In some embodiments, the computer may additionally determine an assigned area of the staff member, compare the location of the staff member and the assigned area of the staff member to determine whether to assign the staff member to the location, and determine the amount of time the staff member is detected in the location. The computer may further wherein to assign the staff member to the location comprises to assign the staff member to a patient assigned to the location based on the location of the staff member and a determination that the amount of time the staff member is detected in the location exceeds the duration threshold.

In some embodiments, to determine the amount of time the staff member is at the location comprises to determine an amount of time the portable transceiver device has been detected at the location.

In some embodiments, the computer may receive, subsequent to assigning the staff member to the location of the staff member, additional location information for the staff member from another proximity sensing device located at another location different than the location. Further, the computer may determine the amount of time the staff member is detected in the other location. Further still, the computer may cancel the assignment of the staff member to the location of the staff member to which the staff member was previously assigned. Yet further still, the computer may assign the staff member to the other location in response to a determination that the amount of time the staff member is detected in the other location exceeds the duration threshold.

In some embodiments, the computer may the staff member to the other location comprises assigning the staff member to a patient to assign to the other location.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the following figures, in which:

FIG. 1 is a diagrammatic view showing a system for location-based automated assignment that includes a hospital information system in network communication with a plurality of sensors for detecting a location of a staff-member;

FIG. 2 is a block diagram showing physical components of an assignment computer of the hospital information system of FIG. 1;

FIG. 3 is a block diagram of an environment that may be established by the assignment computer of FIGS. 1 and 2; and

FIGS. 4-6 are a flow diagram of an embodiment of a method for location-based automated assignment that may be executed by the assignment computer of FIGS. 1 and 2.

### DETAILED DESCRIPTION

Typically, an employee (e.g., an assignment coordinator) at a facility is tasked with managing, or otherwise coordinating, where assignable employees at the facility are assigned. In some facilities, such as a hospital facility, the assignments may be dynamically adjusted throughout the day by the assignment coordinator (e.g., a unit clerk or nurse in the hospital facility setting). However, in some facilities, the location of the assignable employees may be tracked throughout the facility using various short-range wireless communication technologies for automatic identification and data capture (AIDC), such as by using smart cards, radio frequency identification (RFID), etc., that are capable of communicating with a plurality of proximity sensors throughout the facility. According to the present disclosure, a location detected for an assignable employee may be used to automatically re-assign that employee to an area and/or a patient corresponding with that location.

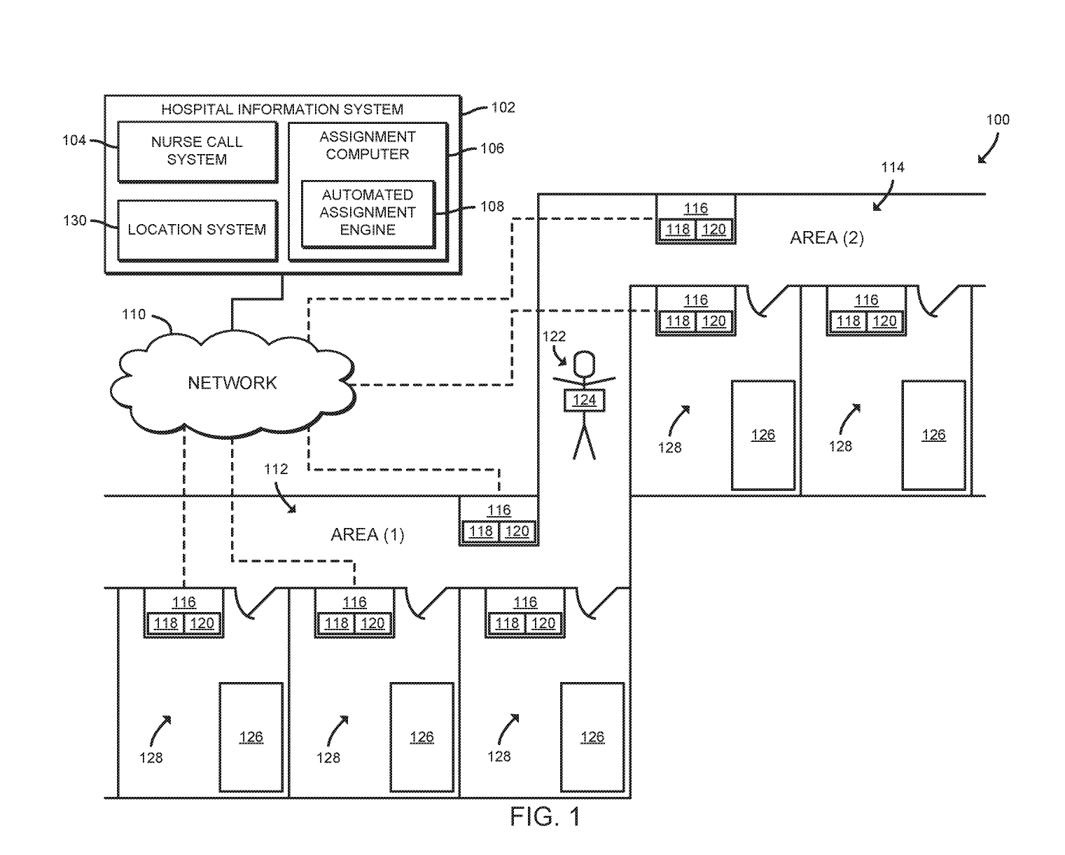

One such embodiment of a system for location-based automated assignment at a facility 100, such as may be administered for a healthcare facility, is diagrammatically illustrated in FIG. 1. The illustrative facility 100 includes a hospital information system 102 communicatively coupled via a network 110 to a plurality of proximity sensing devices 116 located throughout the facility 100. In use, each of the proximity sensing devices 116 is capable of detecting, using one or more wireless communication technologies, the presence of a staff member 122 in the facility 100 within a wireless communication range of the proximity sensing devices 116 using a portable transceiver device 124. It should be appreciated that the wireless communication range may be defined by the wireless communication technology, or wireless communication technologies, employed by each of the proximity sensing devices 116.

To interface with the proximity sensing devices 116, the staff member 122 may be required to carry the portable transceiver device 124 (e.g., a badge, a smartcard, a smartphone, a mobile computing device, etc.) capable of transmitting data to the proximity sensing devices 116. Accordingly, as the staff member 122 navigates the facility 100 during their shift, the proximity sensing devices 116 can detect the staff member 122 within a certain proximity of the proximity sensing devices and provide the location of the staff member 122 within the facility 100 to the hospital information system 102, and more particularly to an assignment computer 106 of the hospital information system 102 that includes an automated assignment engine 108. As will be described in further detail below, the staff member's 122 location within the facility 100 may be received and analyzed by the automated assignment engine 108 to determine whether one or more conditions have been satisfied in order to assign the staff member 122 to an area and/or a patient based on their present location.

For example, as shown in FIG. 1, the staff member 122 is presently between an area 112, designated as area (1), and another area 114, designated as area (2). It should be appreciated that, in some embodiments, more than two areas will be designated within a facility. In furtherance of the example, one of the proximity sensing devices 116 is located on a perimeter of the area 112 (i.e., the proximity sensing device 116 will detect the portable transceiver device 124 upon the portable transceiver device 124 entering into the area 112) and another of the proximity sensing devices 116 is located on a perimeter of the other area 114. As such, as the portable transceiver device 124 moves from the area 112 to the other area 114, for example, the proximity sensing device 116 on the perimeter of the other area 114 can detect the portable transceiver device 124 in response to the portable transceiver device 124 entering into the area 114. Accordingly, that proximity sensing device 116 sends an indication to the automated assignment engine 108 that includes identifying information of the location of the proximity sensing device 116 on the perimeter of the other area 114, as well as identifying information of the portable transceiver device 124 (i.e., an identifier of the staff member 122 to which the portable transceiver device 124 was assigned).

As shown in FIG. 1, additional proximity sensing devices 116 are located within each room 128 of the facility 100. Similar to the proximity sensing devices 116 located at the perimeter of the areas 112, 114, the proximity sensing devices 116 within each room 128 are configured to send an indication to the automated assignment engine 108 that includes identifying information of the location of the proximity sensing device 116 (i.e., corresponding to the room 128) and identifying information of the portable transceiver device 124 (i.e., the identifier of the staff member 122 to which the portable transceiver device 124 is assigned). While the illustrative FIG. 1 only shows a single proximity detection device 116 on the perimeter of the areas 112, 114 and a single proximity detection device 116 in each of the rooms, any number of proximity detection devices 116 may be deployed in additional and/or alternative locations in the facility 100, in other embodiments.

It should be appreciated that the facility 100 has more than one staff member 122, each having their own identifying portable transceiver device 124. It should be further appreciated that, in some embodiments, one or more various types of equipment within the facility 100 may be similarly equipped with transmitters (e.g., tags, bar codes, etc.) capable of wireless communication with the proximity sensing devices 116. In such embodiments, the equipment may additionally or alternatively be assigned based on the location-based automated assignment described herein. In one such embodiment, a patient support device 126 (e.g., a hospital bed, a chair, a lift, a stretcher, and/or any other type of patient support) may be equipped with wireless communication technology such that assignment of the equipment may be assigned according to the functions described herein. Accordingly, in such embodiments, the patient support device 126 may be assigned to a particular area and/or room based on the detected location of the patient support device 126 as reported by the proximity sensing devices 116.

As shown, each of the proximity sensing devices 116 includes network communication circuitry 118 to perform the wireless communication between the hospital information system 102 and proximity sensing devices 116, as well as reader circuitry 120 to perform the wireless communication between the proximity sensing devices 116 and the portable transceiver device(s) 124. The network communication circuitry 118 may be embodied as any communication circuit, device, or collection thereof, capable of enabling communications over the network 110 to and from the proximity sensing devices 116 (e.g., between the hospital information system 102 and the proximity sensing devices 116). The network communication circuitry 118 may be configured to use any one or more communication technologies (e.g., wired and/or wireless communication technologies) and associated communication protocols (e.g., Ethernet, Bluetooth®, Wi-Fi®, WiMAX, etc.) to effect such communication.

The reader circuitry 120 may be embodied as any type of circuit, device, or collection thereof, capable of wirelessly interfacing (i.e., communicating) with a wireless communication component (see, e.g., the portable transceiver device 124) that includes compatible communication technology. Information from the portable transceiver device 124, and from receivers with which the portable transceiver device 124 communicates, may be used to determine the location of the wearer of the portable transceiver device 124 (i.e., the location of the staff member 122). For example, the reader circuitry 120 is configured to communicate with the portable transceiver device 124 to retrieve or receive an identifier unique to the portable transceiver device 124 (e.g., a nurse call/locating badge) that identifies the staff member 122.

The reader circuitry 120 and the portable transceiver device 124 may be configured to use one or more short-range wireless communication technologies for automatic identification and data capture (AIDC), such as radio frequency identification (RFID). In one such embodiment, the portable transceiver device 124 is embodied as an RFID tag (e.g., passive or active) and the reader circuitry 120 is embodied as an RFID reader (e.g., passive or active). It should be appreciated that the wireless communication technology used between the portable transceiver device 124 and the reader circuitry 120 may be employed based on a range capability of the wireless communication technology in use, such that the reader circuitry 120 can only communicate with the portable transceiver device 124 when the portable transceiver device 124 is in a proximity dictated by the range capability of the wireless communication technology.

The illustrative hospital information system 102 includes a nurse call system 104. The nurse call system 104 is configured to operate and manage many of the primary nurse call functions of the hospital information system 102. For example, the nurse call system 104 is configured to receive and manage messages from a location system 130 supporting various connected devices (e.g., the proximity sensing devices 116) usable to determine a location of hospital staff in the facility 100, as well as various equipment located within the facility 100. Accordingly, the nurse call system 104 is further configured to coordinate assignment of patients to a hospital support device 126, and/or to synchronize connected devices within the facility 100 that are in network communication with the nurse call system 104. Additionally or alternatively, the nurse call system 104 is configured to answer, control placement of, and cancel calls, as well as, generate notifications or alarms, acknowledge and cancel notifications and alarms, manage location information for staff and devices, activate and deactivate staff, manage staff-patient assignments, assign and manage roles and responsibilities to staff and devices, and/or manage patient information and patient discharges and transfers.

To facilitate the communication requirements of the hospital information system 102, the hospital information system 102 may include various computing devices, such as any type of computation or computing device capable of performing the functions described herein, including, without limitation, a server (e.g., stand-alone, rack-mounted, blade, etc.), a network appliance (e.g., physical or virtual), a web appliance, a distributed computing system, a processor-based system, a multiprocessor system, a smartphone, a mobile computing device, a tablet computer, a laptop computer, a notebook computer, and/or a computer. Similarly, the assignment computer 106 of the hospital information system 102 that includes the automated assignment engine 108 may be embodied as any type of computation or computing device capable of performing the functions described herein, including, without limitation, a server (e.g., stand-alone, rack-mounted, blade, etc.), a network appliance (e.g., physical or virtual), a web appliance, a distributed computing system, a processor-based system, a multiprocessor system, a smartphone, a mobile computing device, a tablet computer, a laptop computer, a notebook computer, and/or a computer.

The network 110 may be embodied as any type of wired or wireless communication network, including cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), telephony networks, local area networks (LANs) or wide area networks (WANs), global networks (e.g., the Internet), or any combination thereof. As previously described, the proximity sensing devices 116 are in communication with the hospital information system 102 via the network 110. Accordingly, the network 110 may include any number of network devices (e.g., access points, routers, switches, servers, etc.) as needed to facilitate communications between the hospital information system 102 and the proximity sensing devices 116.

Each of the proximity detection devices 116 may be embodied as any type of circuit, device, or collection thereof, capable of detecting an identification device (e.g., the portable transceiver device 124 of the staff member 122) in proximity (i.e., wireless communication range) of that proximity detection device 116. As described previously, in use, the proximity detection devices 116 are configured to detect a presence of a staff member 122 and generate data corresponding to that proximity detection device 116 that detected the presence of the staff member 122, as well as collect data from the portable transceiver device 124 identifying the detected staff member 122. Accordingly, the data of the proximity detection device 116 and the staff member 122 may be transmitted to an external computing device (e.g., the hospital information system 102) for analysis, which will be described in further detail below.

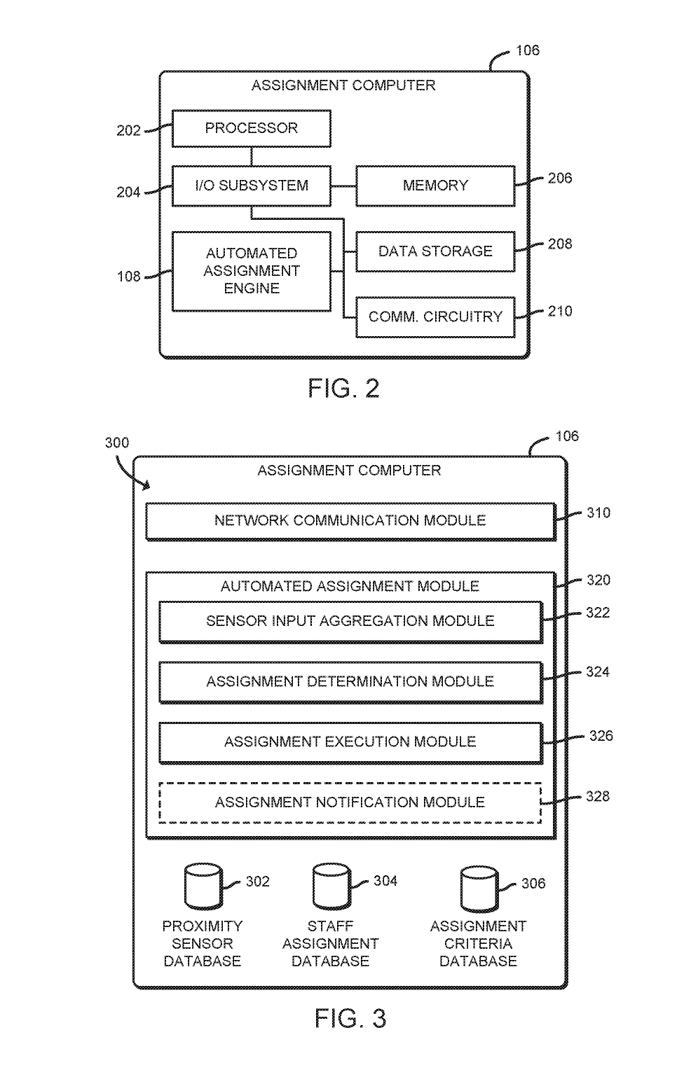

As shown in FIG. 2, the illustrative assignment computer 106 includes a processor 202, an input/output (I/O) subsystem 204, a memory 206, a data storage device 208, and communication circuitry 210, as well as the automated assignment engine 108 of FIG. 1. Of course, in other embodiments, the assignment computer 106 may include other or additional components, such as those commonly found in a computing device (e.g., input/output devices, etc.). Additionally, in some embodiments, one or more of the illustrative components may be incorporated in, or otherwise form a portion of, another component. For example, in some embodiments, the memory 206, or portions thereof, may be incorporated in the processor 202.

The processor 202 may be embodied as any type of processor capable of performing the functions described herein. The processor 202 may be embodied as a single or multi-core processor(s), digital signal processor, microcontroller, or other processor or processing/controlling circuit. The I/O subsystem 204 may be embodied as circuitry and/or components to facilitate input/output operations with the processor 202, the memory 206, and other components of the assignment computer 106. For example, the I/O subsystem 204 may be embodied as, or otherwise include, memory controller hubs, input/output control hubs, integrated sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processor 202, the memory 206, and other components of the assignment computer 106, on a single integrated circuit chip.

The memory 206 may be embodied as any type of volatile or non-volatile memory or data storage capable of performing the functions described herein. In operation, the memory 206 may store various data and software used during operation of the assignment computer 106 such as operating systems, applications, programs, libraries, and drivers. The memory 206 is communicatively coupled to the processor 202 via the I/O subsystem 204, which may be embodied as circuitry and/or components to facilitate input/output operations with the processor 202, the memory 206, and other components of the assignment computer 106. For example, the I/O subsystem 204 may be embodied as, or otherwise include, memory controller hubs, input/output control hubs, integrated sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processors 202, the memory 206, and other components of the assignment computer 106, on a single integrated circuit chip.

The data storage device 208 may be embodied as any type of device or devices configured for short-term or long-term storage of data such as, for example, memory devices and circuits, memory cards, hard disk drives, solid-state drives, or other data storage devices. The data storage device 208 may include a system partition that stores data and firmware code for the assignment computer 106. The data storage device 208 may also include an operating system partition that stores data files and executables for an operating system of the assignment computer 106.

The communication circuitry 210 may be embodied as any communication circuit, device, or collection thereof, capable of enabling communications over the network 110, such as between the hospital information system 102 and the network communication circuitry 118 of the proximity detection devices 116. The communication circuitry 210 may be configured to use any one or more communication technologies (e.g., wired and/or wireless communication technologies) and associated protocols (e.g., Ethernet, Bluetooth®, Wi-Fi®, WiMAX, etc.) to effect such communication.

Referring now to FIG. 3, in an illustrative embodiment, the assignment computer 106 establishes an environment 300 during operation. The illustrative environment 300 includes a network communication module 310 and an automated assignment module 320. Each of the modules, logic, and other components of the environment 300 may be embodied as hardware, software, firmware, or a combination thereof. For example, each of the modules, logic, and other components of the environment 300 may form a portion of, or otherwise be established by, the processor 202 or other hardware components of the assignment computer 106. As such, in some embodiments, one or more of the modules of the environment 300 may be embodied as a circuit or collection of electrical devices (e.g., network communication circuitry 310, automated assignment circuitry 320, etc.).

In the illustrative environment 300, the assignment computer 106 includes a proximity sensor database 302, a staff assignment database 304, and an assignment criteria database 306, each of which may be accessed by the various modules and/or sub-modules of the assignment computer 106. It should be appreciated that the assignment computer 106 may include other components, sub-components, modules, sub-modules, and/or devices commonly found in a computing device, which are not illustrated in FIG. 3 for clarity of the description.

The network communication module 310 is configured to facilitate inbound and outbound network communications (e.g., network traffic, network packets, network flows, etc.) to and from the assignment computer 106. To do so, the network communication module 310 is configured to receive and process network packets from other computing devices (e.g., the proximity detection devices 116). Additionally, the network communication module 310 is configured to prepare and transmit network packets to other computing devices (e.g., proximity detection devices 116). Accordingly, in some embodiments, at least a portion of the functionality of the network communication module 310 may be performed by the communication circuitry 210.

The automated assignment module 320 is configured to perform automated assignment of staff members 122 to patients in their respective rooms 128 and/or areas (e.g., the areas 112, 114 of FIG. 1) within the facility 100 based on the location of the staff members 122. To do so, the illustrative automated assignment module 320 includes a sensor input aggregation module 322, an assignment determination module 324, and an assignment execution module 326. It should be appreciated that at least a portion of the functions performed by the automated assignment module 320 as described herein may be executed in hardware by the automated assignment engine 108.

The sensor input aggregation module 322 is configured to receive and aggregate proximity sensor data from the various proximity detection devices 116. The proximity sensor data may include any data that is indicative of a detected presence of an identifying device (e.g., the portable transceiver device 124). As such, the proximity sensor data may include, but is not limited to, a time of the detected presence, an identifier of the staff member 122 that was detected, an identifier of the proximity detection device 116 that detected the presence of the identifying device, and/or a type of the proximity detection device 116. In some embodiments, such proximity sensor data may be stored in the proximity sensor database 302.

The assignment determination module 324 is configured to analyze the proximity sensor data to determine whether the staff member 122 is in an area in which the staff member 122 is presently assigned. Accordingly, in some embodiments, the assignment determination module 324 may be configured to retrieve the assigned patients and/or area of the staff member 122 from the staff assignment database 304, as well as assignment criteria from the assignment criteria database 306. The assignment criteria may include any data that defines parameters that must be met before the assignment determination module 324 can determine that the staff member 122 need to be re-assigned based on their present location. Such assignment criteria, as will be described in further detail below, may include being detected by more than one of the proximity sensing devices 116 and/or having been in the proximity of one of the proximity sensing devices 116 for a period of time that meets or exceeds a duration threshold. It should be appreciated that, in some embodiments, different assignment areas (e.g., the areas 112, 114) may have different assignment criteria.

The assignment execution module 326 is configured to execute the area assignment change for the staff member 122 in response to a determination that the assignment determination module 324 determined the assignment criteria has been met. To do so, the assignment execution module 326 may be configured to provide an indication to the nurse call system 104 to assign the staff member 122 to a new patient and/or area based on the present location (e.g., one of the areas 112, 114, one of the rooms 128, etc.) of the staff member 122. Accordingly, the indication may include an identifier of the staff member 122 and an identifier of the location (e.g., one of the areas, one of the rooms 128, etc.) in which the staff member 122 is to be assigned. It should be appreciated that patient-to-room assignments may also be stored in the assignment computer 106, such that the assignment execution module 326 may assign the staff member 122 to a patient based on the patient's room assignment.

In some embodiments, the automated assignment module 320 may additionally include an assignment notification module 328. The assignment notification module 328 may be configured to generate a notification indicative of a pending or completed reassignment of the staff member 122. The generated notification may be a signal transmitted to an audible and/or visual device that is capable of receiving and interpreting the signal to perform a task associated with the signal (i.e., display a message corresponding to the signal, play an audio clip corresponding to the signal, etc.). For example, the notification may be an alphanumeric message sent to one of the proximity sensing devices 116, a portable transceiver device, such as a smartphone, a pager, a PDA, a wireless communication badge (e.g., the portable transceiver device 124), a wireless phone handset, and/or any other device having message display and/or audio playback capability. In furtherance of the example, in some embodiments, the notification may prompt the staff member 122 to confirm the assignment (e.g., via an input component of the audible and/or visual device) prior to the assignment execution module 326 executing the area assignment change.

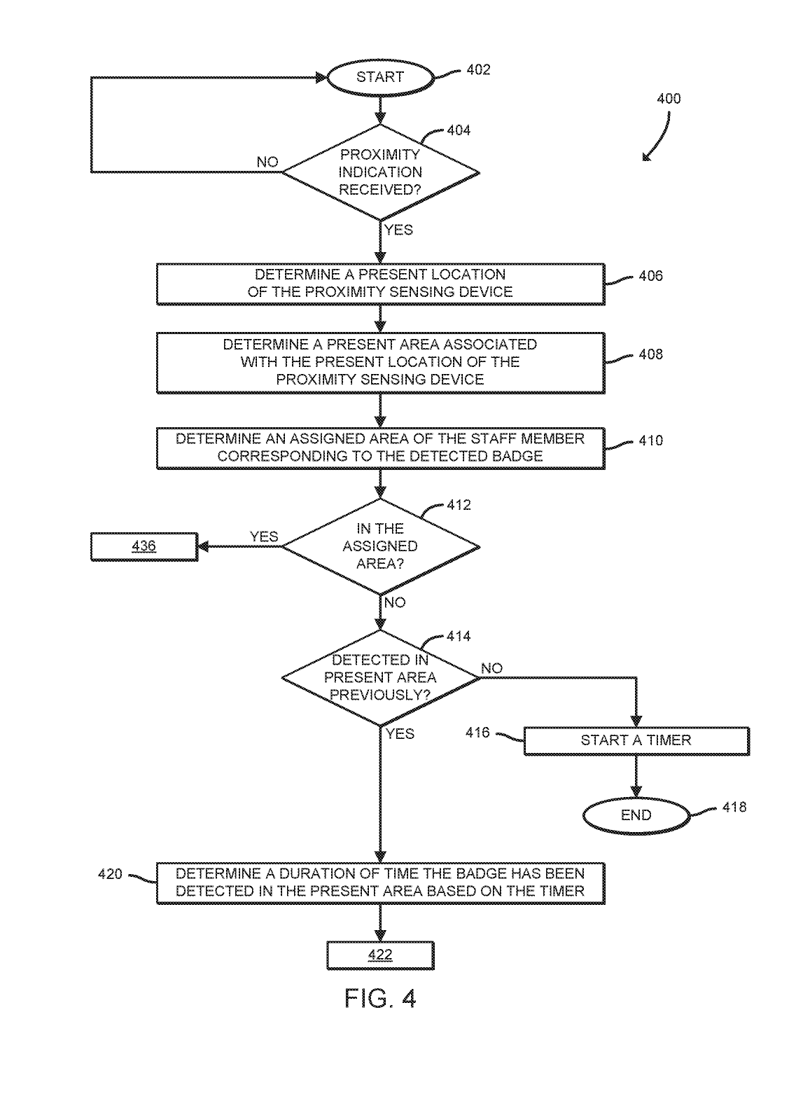

Referring now to FIGS. 4-6, in use, the illustrative assignment computer 106 executes a method 400 for location-based automated assignment. It should be appreciated that at least a portion of the method 400 may be executed or otherwise processed by the automated assignment engine 108 of the assignment computer 106. The method 400 begins with step 402, in which the assignment computer 106 receives a proximity indication. The proximity indication may be a signal received at the assignment computer 106 from one of the proximity sensing devices 116 indicating that proximity sensing device 116 detected a wireless communication device (e.g., the portable transceiver device 124).

In some embodiments, the proximity indication may include an identifier of the portable transceiver device 124 such that a location (e.g., a room number, a hallway name, global positioning system (GPS) coordinates, etc.) of the carrier (e.g., the staff member 122) of the portable transceiver device 124 may be identified. The proximity indication may additionally include an identifier of the staff member 122 and/or any other identifying information. Accordingly, in step 404, the assignment computer 106 determines whether the proximity indication was received. If not (e.g., the signal was not a proximity indication), the method 400 loops back to step 402 until the next signal is received; otherwise, the method 400 advances to step 406.

In step 406, the assignment computer 106 determines a present location of the proximity sensing device 116 that detected the portable transceiver device 124 based on at least one of the identifiers of the proximity indication provided by the proximity sensing device 116 that detected the portable transceiver device 124. Based on the present location, in step 408, the assignment computer 106 determines a present area (see, e.g., the areas 112, 114) associated with the present location determined in step 406. It should be appreciated that, in some embodiments, more than one of the proximity sensing devices 116 may be located within a particular area, such as at an entry/exit of a perimeter of an area, within a room in the area, etc. In step 410, the assignment computer 106 determines an assigned area to which the staff member 122 is presently assigned.

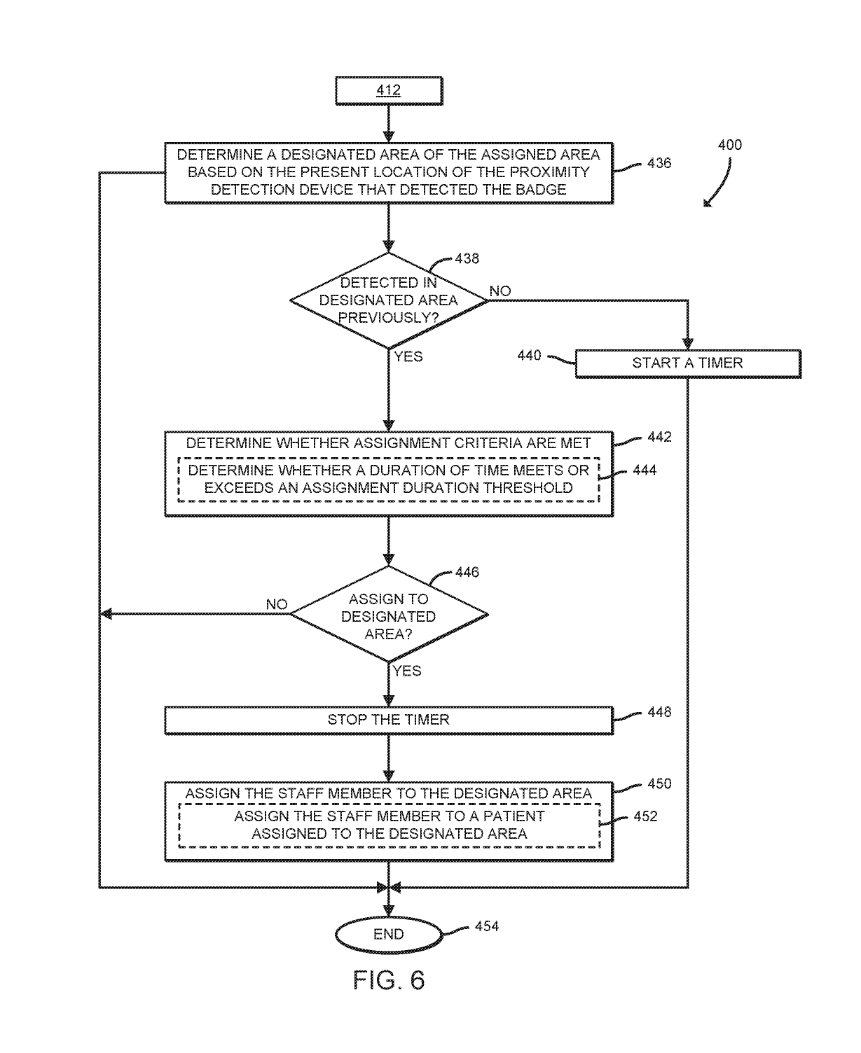

In step 412, the assignment computer 106 determines whether the proximity sensing device 116 that detected the portable transceiver device 124 is in the assigned area of the staff member 122. In other words, the assignment computer 106 compares the present area with the assigned area to determine whether they are the same. If the proximity sensing device 116 that detected the portable transceiver device 124 is in the assigned area, the method 400 branches to step 436, shown in FIG. 6, which is discussed below; otherwise, the method advances to step 414, wherein the assignment computer 106 determines whether the portable transceiver device 124 (i.e., the staff member 122) was detected in the present area previously (i.e., in a most recent iteration of the method 400). For example, the assignment computer 106 may determine whether the present area determined in step 408 matches a previous area in which the portable transceiver device 124 was detected. If the portable transceiver device 124 was not detected in the present area previously, the method 400 advances to step 416. In step 416, the assignment computer 106 starts a timer before advancing to step 418, wherein the method 400 terminates.

Otherwise, if the assignment computer 106 determines whether the portable transceiver device 124 was detected in the present area previously (e.g., the portable transceiver device 124 was previously detected by another of the proximity sensing devices 116 also in the present area), the method 400 proceeds to step 420, wherein the assignment computer 106 determines a duration of time the portable transceiver device 124 has been detected in the present area based on the timer (e.g., that was started in a previous iteration of method 400 at step 416). From step 420, the method 400 advances to step 422, in which the assignment computer 106 determines whether reassignment criteria is met. It should be appreciated that, in some embodiments, the reassignment criteria may be determined using a policy associated with the area, the patient, the facility 100, the staff member 122, and/or some other condition.

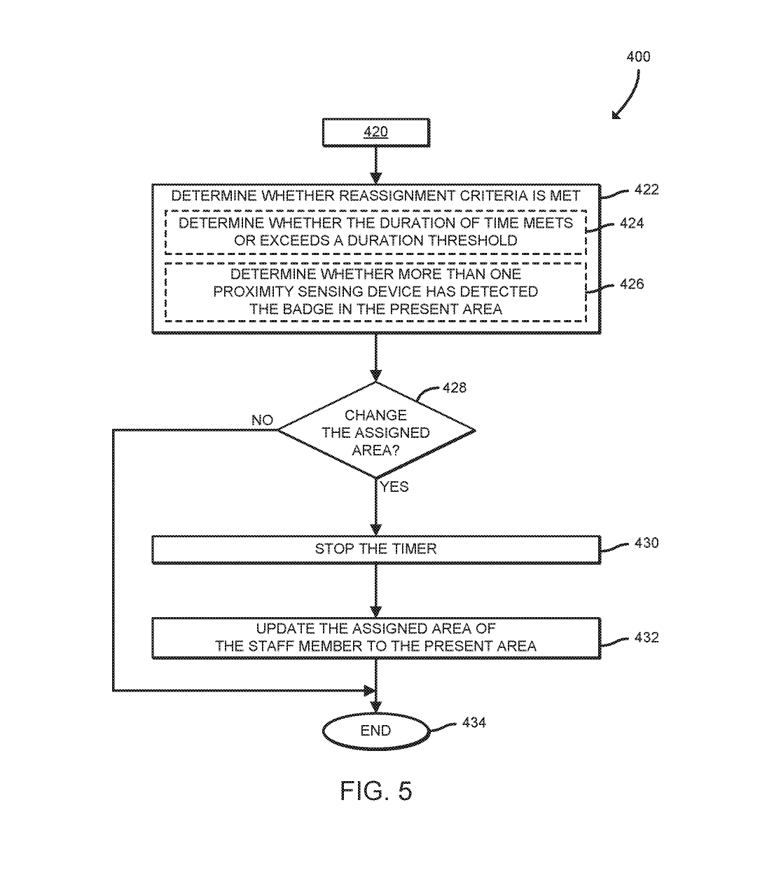

In some embodiments, in step 424, shown in FIG. 5, the assignment computer 106 may determine whether the reassignment criteria is met by determining whether the duration of time determined in step 420 meets or exceeds a duration threshold. Additionally or alternatively, in some embodiments, in step 426, the assignment computer 106 may determine whether the reassignment criteria is met by determining whether more than one of the proximity sensing devices 116 located within the present area has detected the portable transceiver device 124 in the present area. For example, one proximity sensing device 116 on a perimeter of the area may have detected entry into the area and another proximity sensing device 116 within the area (e.g., in a room 128) may have detected further entry into the area.

In step 428 of FIG. 5, the assignment computer 106 determines whether to change the assigned area of the staff member 122 based on whether the reassignment criteria was met in step 422. If not, the method 400 branches to step 434, wherein the method 400 terminates. Otherwise, if the assignment computer 106 determines to change the assigned area of the staff member 122, the method 400 advances to step 430, in which the timer that was started in step 416 is stopped. In step 432, the assignment computer 106 updates the assigned area of the staff member 122 to the present area before proceeding to step 434, wherein the method 400 terminates. It should be appreciated that, in some embodiments, subsequent to updating the assigned area of the staff member 122 to the present area, one or more patients of the present area may be assigned to the staff member 122.

Referring back to step 412 of FIG. 4, as noted previously, if the assignment computer 106 determines the portable transceiver device 124 is in the assigned area, the method 400 branches to step 436. In step 436, the assignment computer 106 determines a designated area (e.g., one of the rooms 128 of one of the areas 112, 114 of FIG. 1, based on the present location determined at step 406) of the assigned area based on the present location of the proximity detection device 116 that detected the portable transceiver device 124. In step 438, the assignment computer 106 determines whether the portable transceiver device 124 was detected in the designated area (i.e., determined at step 436) previously (i.e., in a most recent previous iteration of the method 400). If not, the method advances to step 440, wherein the assignment computer 106 starts a timer before the method 400 exits at step 454.

In step 442, the assignment computer 106 determines whether assignment criteria are met. To do so, in some embodiments, in step 444, the assignment computer 106 may determine whether a duration of time (i.e., based on the timer started at step 440 in a previous iteration) that the portable transceiver device 124 was detected in the designated area since it was previously detected exceeds an assignment duration threshold. It should be appreciated that, in some embodiments, each of the proximity detecting devices 116 may poll whether a portable transceiver device 124 is detected within the proximity range (i.e., based on the wireless communication range associated with the portable transceiver devices 124) at a predetermined time interval.

In step 446, the assignment computer 106 determines whether to assign the staff member 122 to the designated area based on whether the assignment criteria has been met in step 442. If not, the method 400 proceeds to step 454, wherein the method 400 terminates. Otherwise, if the staff member 122 is to be assigned to the designated area, the method advances to step 448, wherein the assignment computer 106 stops the timer. In step 450, the assignment computer 106 assigns the staff member 122 to the designated area. In some embodiments, the assignment computer 106 may assign the staff member to a patient assigned to the designation area before the method 400 advances to step 454, wherein the method 400 exits.

Although certain illustrative embodiments have been described in detail above, variations and modifications exist within the scope and spirit of this disclosure as described and as defined in the following claims. The drawings are provided to facilitate understanding of the disclosure, and may depict a limited number of elements for ease of explanation. Except as may be otherwise noted in this disclosure, no limits on the scope of patentable subject matter are intended to be implied by the drawings.

1. A method for location-based automated assignment, the method comprising:
receiving, by a computer, location information from a proximity sensing device communicatively coupled to the computer, wherein the proximity sensing device is located in a nursing unit of a healthcare facility, and wherein the location information includes an identifier of a staff member of the healthcare facility associated with a portable transceiver device detected by the proximity sensing device and a location of the proximity sensing device in the healthcare facility that detected the portable transceiver device;
determining, by the computer, whether to assign the staff member to the location of the staff member based on whether an amount of time the staff member is detected in the location exceeds a duration threshold; and
assigning, by the computer, the staff member to the location of the staff member based on a determination that the amount of time the staff member is detected in the location exceeds the duration threshold.

2. The method of claim 1, wherein assigning the staff member to the location comprises assigning the staff member to a patient assigned to the location.

3. The method of claim 1, wherein the location of the staff member comprises a room of a patient of the healthcare facility.

4. The method of claim 1, wherein the location of the staff member comprises a nursing unit of the healthcare facility.

5. The method of claim 1, further comprising:
determining, by the computer, an assigned area of the staff member;
comparing, by the computer, the location of the staff member and the assigned area of the staff member to determine whether to assign the staff member to the location; and
determining, by the computer, the amount of time the staff member is detected in the location,
wherein assigning the staff member to the location comprises assigning the staff member to a patient assigned to the location based on the location of the staff member and a determination that the amount of time the staff member is detected in the location exceeds the duration threshold.

6. The method of claim 5, wherein determining the amount of time the staff member is at the location comprises determining an amount of time the portable transceiver device has been detected at the location.

7. The method of claim 1, further comprising:
receiving, by the computer and subsequent to assigning the staff member to the location of the staff member, additional location information for the staff member from another proximity sensing device located at another location different than the location;
determining, by the computer, the amount of time the staff member is detected in the other location;
cancelling, by the computer, the assignment of the staff member to the location of the staff member to which the staff member was previously assigned; and
assigning, by the computer, the staff member to the other location in response to a determination that the amount of time the staff member is detected in the other location exceeds the duration threshold.

8. The method of claim 7, wherein assigning the staff member to the other location comprises assigning the staff member to a patient assigned to the other location.

9. A system for location-based automated assignment, the system comprising:
a plurality of proximity sensing devices located in different locations in a nursing unit of a healthcare facility, wherein each of the proximity sensing devices is configured to detect a portable transceiver device associated with a staff member; and
a computer communicatively coupled to the proximity sensing devices, wherein the computer is configured to:
receive location information from each of the proximity sensing devices, wherein the location information includes an identifier of the staff member of the healthcare facility associated with a portable transceiver device detected by the proximity sensing device and a location of the proximity sensing device in the healthcare facility that detected the portable transceiver device;
determine whether to assign the staff member to the location of the staff member based on whether an amount of time the staff member is detected in the location exceeds a duration threshold; and
assign the staff member to the location of the staff member based on a determination that the amount of time the staff member is detected in the location exceeds the duration threshold.

10. The system of claim 9, wherein to assign the staff member to the location comprises to assign the staff member to a patient assigned to the location.

11. The system of claim 9, wherein the location of the staff member comprises a room of a patient of the healthcare facility.

12. The system of claim 9, wherein the location of the staff member comprises a nursing unit of the healthcare facility.

13. The system of claim 9, wherein the computer is further configured to:
determine an assigned area of the staff member;
compare the location of the staff member and the assigned area of the staff member to determine whether to assign the staff member to the location; and
determine the amount of time the staff member is detected in the location,
wherein to assign the staff member to the location comprises to assign the staff member to a patient assigned to the location based on the location of the staff member and a determination that the amount of time the staff member is detected in the location exceeds the duration threshold.

14. The system of claim 13, wherein to determine the amount of time the staff member is at the location comprises to determine an amount of time the portable transceiver device has been detected at the location.

15. The system of claim 9, wherein the computer is further configured to:
receive, subsequent to assigning the staff member to the location of the staff member, additional location information for the staff member from another proximity sensing device located at another location different than the location;
determine the amount of time the staff member is detected in the other location;
cancel the assignment of the staff member to the location of the staff member to which the staff member was previously assigned; and
assign the staff member to the other location in response to a determination that the amount of time the staff member is detected in the other location exceeds the duration threshold.

16. The system of claim 15, wherein to assign the staff member to the other location comprises assigning the staff member to a patient to assign to the other location.
